(19) United States
(12) Patent Application Publication
(10) Pub. No.: US 2001/0054089 A1
(43) Pub. Date: Dec. 20, 2001

(54) System and method for providing a guided tour of a web site

(76) Inventors: Kevin Tso, San Jose, CA (US); Ken Li, Arcadia, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/851,028

(22) Filed: May 7, 2001

Related U.S. Application Data
(60) Provisional application No. 60/203,226, filed on May 5, 2000.

(51) Int. Cl. G06F 15/16

(52) U.S. Cl. 709/219

(57) ABSTRACT

A system and method for electronically providing a guided tour using a plurality of web pages having the steps of

storing information about web pages in a database, storing information about an order of display of the web pages in the database, receiving a request for web page information, and sending information about the web pages to a user to enable the user to view the plurality of web pages in the order of display stored in the database.

### CROSS-REFERENCE TO RELATED APPLICATION(S)

This application claims priority of provisional application No. 60/203,226, filed on May 5, 2000, entitled “GUIDED TOUR OF A WEB SITE”, the entire contents of which are hereby incorporated herein by reference.

### BACKGROUND OF THE INVENTION

The present invention is directed to a system and method for presenting guided tours, and more particularly, to presenting guided tours of web sites over the Internet.

A primary way that a business or person can show another person a web site remotely is to send that person a link to the web site. However, once a recipient of the link follows the link to a web site with their Internet browser, the recipient of the link finds themselves without further direction. The recipient may be confused by the number of links on the web page. The recipient may navigate to a portion of a web site different from the portion that the sender of the link wanted the recipient to see. With slower connections, a user may waste a significant amount of time downloading text and images that they do not need trying to get to the information that the sender was trying to provide for them by sending them the link.

### SUMMARY OF THE INVENTION

The present invention is for a method for electronically providing a guided tour of a plurality of web pages. Information about web pages selected by a guided tour builder is stored in a database. The order that the guided tour builder wants the web pages displayed in is also stored in the database. When a request for web page information is received from a guided tour viewer, information about the web pages in the guided tour is to the viewer in the order specified by the guided tour builder. The viewer is then able to view the web pages in the display order selected by the guided tour builder.

The guided tour builder is prompted to select web pages for a guided tour. Selected web pages are received from the guided tour builder. The guided tour builder is prompted to arrange the selected web pages into an order for presentation in a guided tour. A guided tour order is received from the guided tour builder.

In an additional embodiment of the present invention, the guided tour builder is prompted to select a time lapse in between the sending of each of the plurality of web pages to the second user. The time lapse functions to display a particular web page in the guided tour for a pre-specified period of time. A time lapse is received from the guided tour builder. The time lapse specified by the user is stored in the guided tour database. In an additional embodiment, the guided tour builder is prompted to select a different time lapse for each page in the guided tour, and the time lapse received for each web page is stored in the database corresponding to the web page. When the guided tour is sent to a viewer, each time information about a web page is sent to a the viewer a timer is reset. The timer tolls the time lapse before displaying each of the plurality of web pages to the second user. In an embodiment, later pages in the guided tour are loaded and cached while the timer is tolling the time lapse on the earlier pages in the guided tour.

In an additional embodiment, the guided tour builder is prompted to add an annotation onto each of the web pages. The annotation may be text, graphics, sound, and video. As an annotation is received from the guided tour builder, the annotation is stored in the database correlating to the web page or web pages for which the annotation was created. When a viewer requests information about an annotated web page, the viewer is sent information about the annotation along with the information about the corresponding web page to the annotation.

In another embodiment, the guided tour viewer is prompted to receive information about a web page earlier in the guided tour order than the web page that was most recently sent. If a request to receive information about a web page earlier in the order to the web page last sent is received, then information about a web page earlier in the order to the web pages last sent is sent to the viewer. Likewise, a guided tour viewer is prompted to receive information about a web page later in the order to the web pages last sent. If a request to receive information about a web page later in the order to the web pages last sent is received, then information about a web page later in the order to the one of the web page last sent is sent to the viewer.

In yet another embodiment, the guided tour viewer is sent a list containing information about each of the web pages in the guided tour and prompted to receive a viewer's selection of one or more of the web pages. Once a selection of a web page is received from the viewer, the viewer is sent information about the web pages selected by the user.

In an additional embodiment, the guided tour builder is prompted to select an expiration date for the guided tour. If an expiration date is received from the guided tour builder, then the expiration date is stored in the database corresponding to the guided tour. Upon receipt of a request for a guided tour from a viewer, the expiration date of the guided tour is compared to the current date. If the expiration date of the guided tour is earlier than the current date, then the viewer's request for a guided tour is denied.

A system for providing electronic guided tours has a first user device coupled to a computer network, a second user device coupled to the computer network, a database coupled to the computer network for storing information about web pages and about the order that the web pages are displayed in a guided tour. A server is also coupled to the computer network. Additionally, web pages may be resident on a third party content provider device coupled to the computer network. In an embodiment of the present invention, the computer network is the Internet.

### BRIEF DESCRIPTION OF THE DRAWINGS

A further understanding and appreciation for the present invention will now be had in conjunction with the following drawings and detailed description wherein:

FIG. 1 is an overview of a system and method for providing guided tours of a web site according to an embodiment of the present invention;

FIG. 2 is a diagram showing a system for providing guided tours of a web site according to an embodiment of the present invention;

FIG. 3 is a diagram showing a sequence of events and options presented to a user authorized to create guided tours according to an embodiment of the present invention;

FIG. 4 is a flowchart showing a process of guided tour creation according to an embodiment of the present invention;

FIG. 5 is a screen capture showing guided tour creation controls according to an embodiment of the present invention; and

FIG. 6 is a screen capture showing navigation controls for a viewer viewing a guided tour according to an embodiment of the present invention.

### DETAILED DESCRIPTION OF THE INVENTION

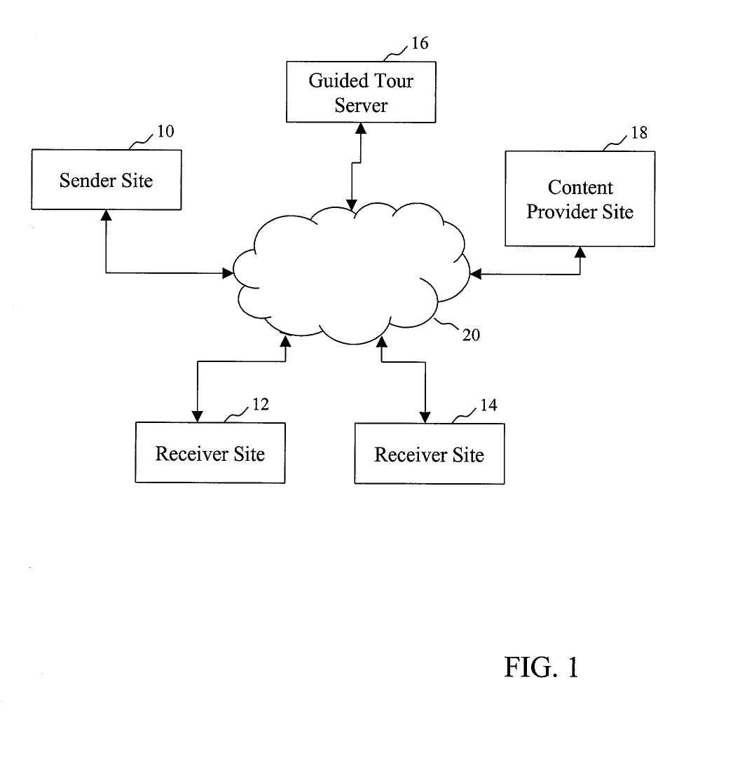

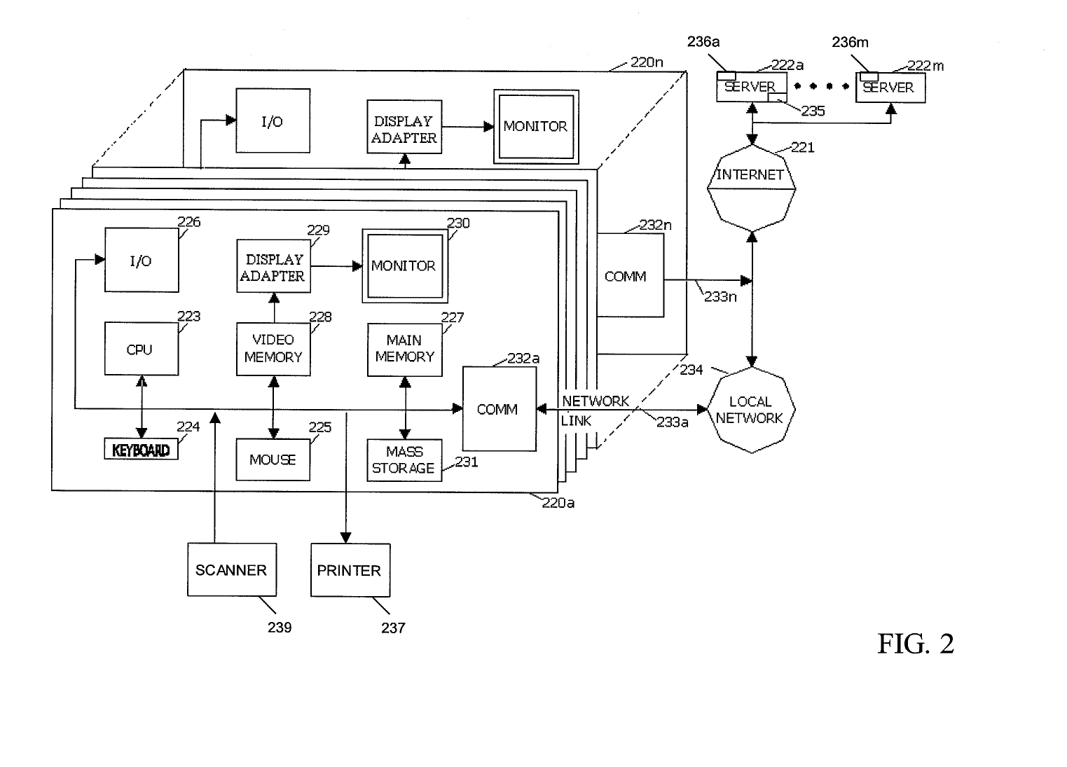

A system for creating guided tours of web sites in accordance with an embodiment of the present invention is illustrated in FIGS. 1 and 2. A sender 10 sends a hotlink to a guided tour server 16 to one or more receivers 12, 14. Each receiver open an Internet browser and points the Internet browser to the guided tour server. The guided tour server 16 provides the receiver 12,14 with a guided tour of a web site. The guided tour may draw content from one or more other web sites 18. The sender, receivers, guided tour server, and any other sites used in the guided tour communicate through a remote communication interface 20. In an embodiment of the present invention, the remote communication interface is the Internet.

The system of FIG. 2 has multiple user devices 220a-220n coupled to a guided tour server 222a-222m through one or remote communication interfaces. In the embodiment described, the remote communication interface comprises the Internet, although in alternative embodiments the remote communication interface comprises an Intranet or other computer to computer interface.

The Internet has recently been popularized by the rapid success of the World Wide Web (WWW or Web). The Web links together a variety of computers from around the world and various topics in a non-sequential web of associations which permit a user to browse from one topic to another, regardless of the format and order of topics. Users access and browse the Web using a web browser that generally resides and is executed on the user's computer. Commercially available web browsers such as Netscape's Navigator™ and Microsoft Internet Explorer™ are very common and accessible by personal computer (PC) users. The web browser allows a user to retrieve and render hyper-media content from the network of computers within the Web, including text, sound, video and other types of data. This hyper-media content is stored on different web sites.

Web sites are locations on server computers that are accessible through the Internet. A variety of information, such as hyper media contents and databases can be stored on a web site and be accessed by users with computers connected to the Internet. One of the applications of the Web is its capability to link a web site with a database so that users can search for information. In essence, the web site becomes the user interface (UI) for database applications enabling a user to select search criteria and execute searches of a database that resides on a remote computer. To serve up pages, web sites need a server (a host computer) and server software that runs on the Server. The host computer manages the communication protocols and houses the pages and related software required to create a web site on the Internet. Host computers spread throughout the Internet can house different web sites.

The Internet works based on a client/server model. In this model, a client computer communicates with a server computer on which information resides and the client computer depends on the server to deliver requested information and services. These services may involve searching for information and sending it back to the client, such as when a database on the Web is queried. Other examples of these services are delivering web pages through a web site, and handling incoming and outgoing email. Typically, the client is a PC user using a browser to connect to and search the servers. The servers (also known as hosts) are usually more powerful computers that house the data and databases. The client/server model enables the Web to be conceived of a limitless file storage medium distributed among thousands of host computers, all accessible by any individual PC user.

The web site and the hosts that make up the World Wide Web need to have unique identifiers so that a client computer can locate and retrieve information and web pages. For example, the unique identifier for a host computer is called IP (Internet Protocol) address and the unique identifier for a web site (web page) is called the URL (Uniform Resource Locator). A URL indicates where the host computer is located, the location of the web site on the host, and the name of the web page and the file type of each document, among other information.

Home and small business users connect to the Internet through Internet service providers using modems and common telephone or cable networks. Wireless and satellite connections are also possible. Larger businesses typically obtain access to the Internet through their private computer networks, using appropriate safeguards to prevent unauthorized access by outside parties to a company's private network.

FIG. 2 shows a block diagram of a typical Internet client/server environment used by the users and server in one embodiment of the present invention. The user devices 220a-220n used by the users are connected to the Internet 221 through the communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by user devices 220a-220n. In one embodiment of the present invention, a database for storing information about guided tours resides on at least one of the servers 222a-222m and is accessible by users using one or more of the user devices 220a-220n to make and view guided tours.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more user devices 220a-220n may be connected to a local network 234. An Input/Output (I/O) device 226 reads data from various data sources and outputs data to various data destinations. Optionally, one or more of the user devices 220a-220n may include a printer 237 for printing receipts and a scanner 239 for scanning pictures. In alternative embodiments of the present invention, the user device may be a personal digital assistant, a set-top box, a laptop, a cellular phone, and other devices that can access a remote communication interface.

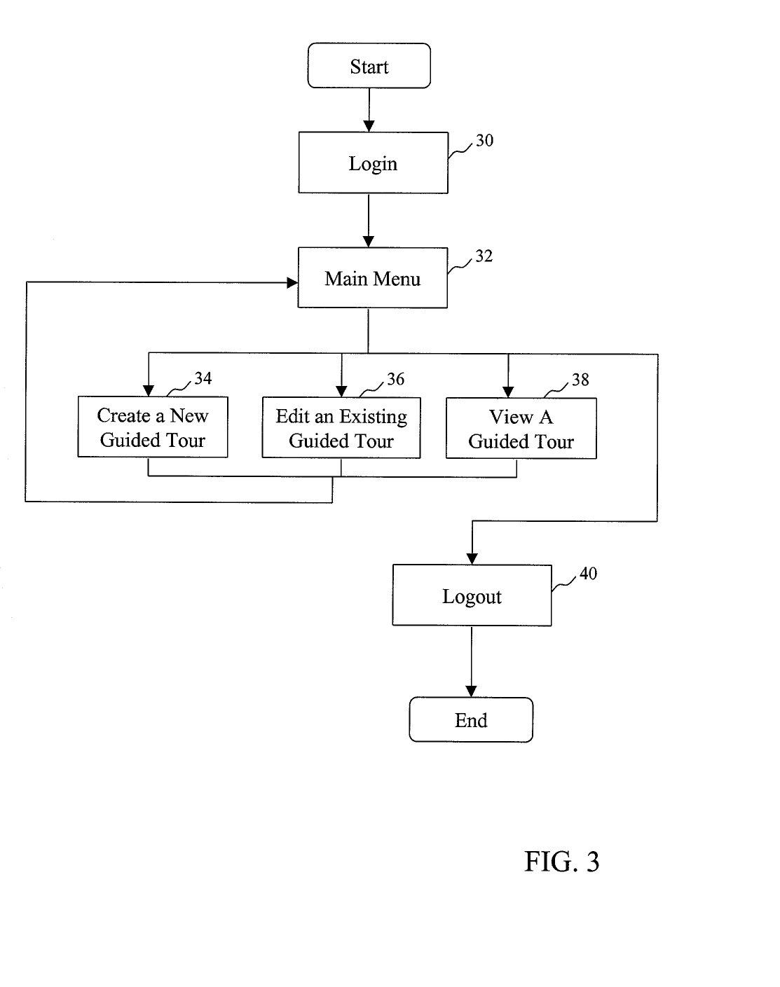

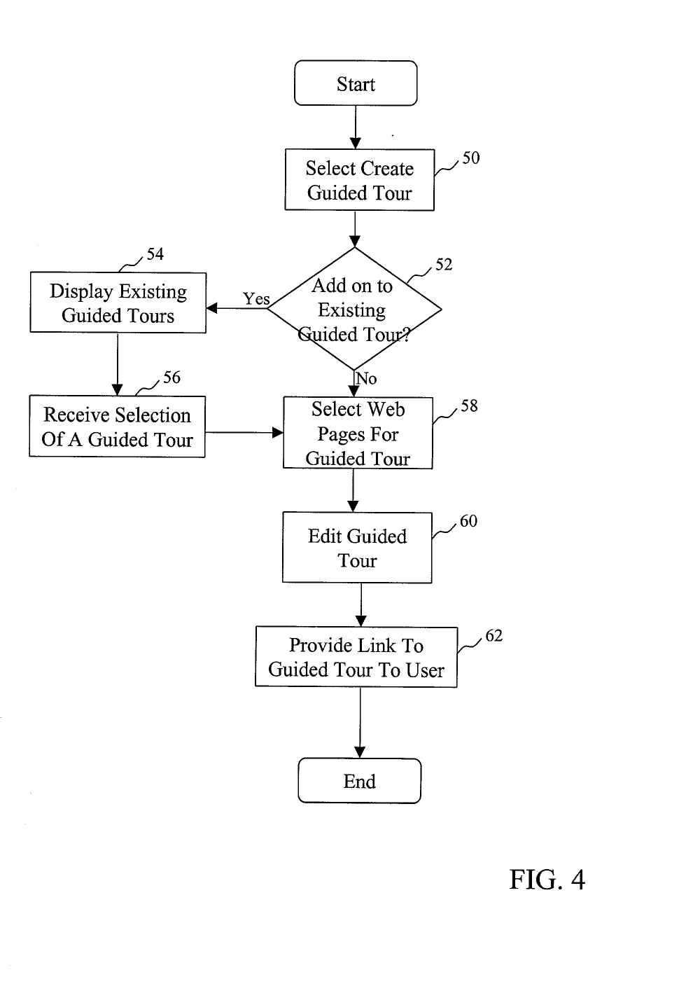

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 236a-236m, such as a hard disk, a CD drive, or a DVD for loading computer software. When a software such as the software responsible for executing the processes in FIGS. 3 and 4 is loaded on the server 222a, an off-the-shelf web management software or load balancing software may distribute the different modules of the software to different servers 222a-222m. Therefore, in one embodiment, the computer program responsible for executing the present invention resides on one or more servers. Databases to carry out the processes of FIGS. 3 and 4 can be created, maintained and edited in many different types of database software including Access, FoxPro, and Oracle. In one embodiment of the present invention the database software is SQL Server 7.

An exemplary web site location 235 is shown on server 222a in FIG. 2. The web site 235 is the UI for accessing the database described below. The web site 235 has a unique address that is used by the users to access server 222a (in this example) and the web site location on the server 222a. The computer software for executing the processes of the present invention may also reside on the web site 235.

As shown in FIG. 3, a user directs their Internet browser to the guided tour server and requests content. The guided tour server sends a login screen 30 to the user. In an embodiment of the present invention, the user is prompted to enter a username and password for authentication or to open a new account. If the user enters a username and password, the user is taken to a main menu 32 where they are prompted to select an option. In an embodiment, the user is prompted to create a new guided tour 34, to edit an existing guided tour 36, to view a guided tour 38, or to log out of the guided tour server.

If the user elects to open a new account, the user is prompted to enter a user name and password. In an additional embodiment, the user is prompted to enter additional information such as an e-mail address and their name for tracking purposes. Once the user has entered this information, the user is forwarded to the main menu 30.

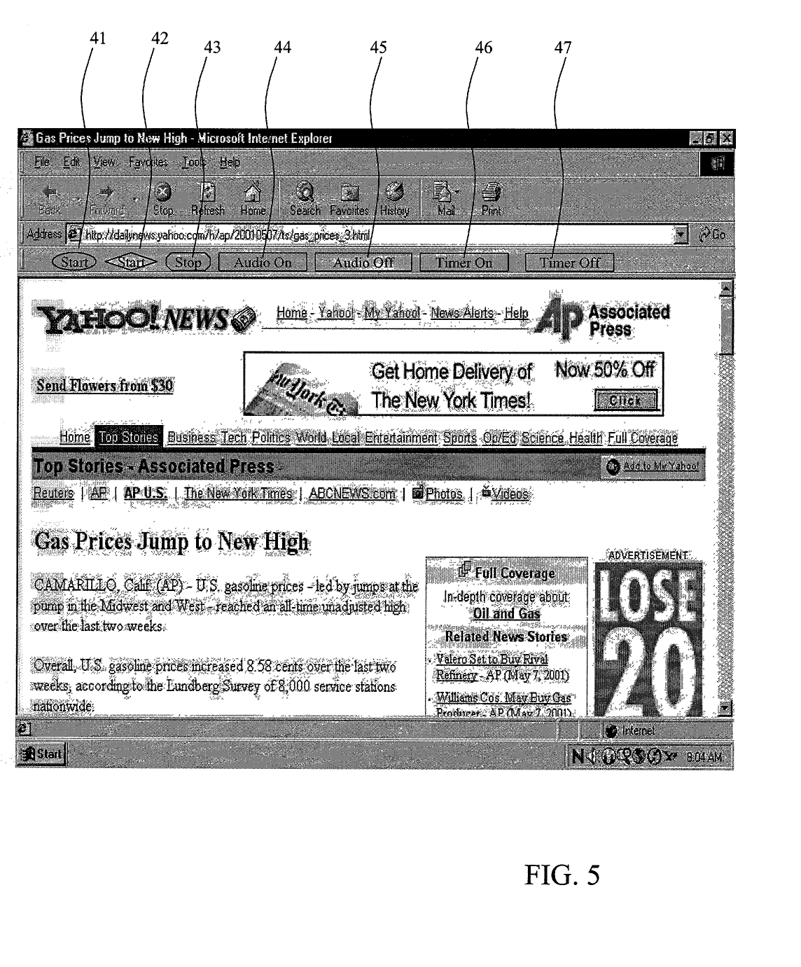

As shown in FIG. 4, if the user elects to create a new guided tour 50, the user is prompted to add on to an existing guided tour or start a completely new guided tour 52. If the user elects to begin a completely new guided tour, then the guided tour server provides the user with a new frame or window with a set of guided tour creation controls. In an additional embodiment, the guided tour creation controls are selected from menus at the top of the screen to avoid limiting the screen area available for web page viewing by the user recording the guided tour. In an embodiment, shown in FIG. 5, the guided tour creation controls include a start button 41, a record button 42 and a stop button 43. In an additional embodiment, the guided tour creation controls also include an audio on button 44, an audio off button 45, a timer start button 46 and a timer stop button 47.

If the user elects to add on to a previously created guided tour, then the user is displayed a list of previously created guided tours available to the user 54. In an embodiment, the user can add on to a guided tour created by another user. Alternatively, the user can only add on to guided tours that they have created. Once the guided tour server receives a selection 56 of a guided tour from the displayed list, the guided tour server provides the user with a new frame or window with a set of additional controls as described above.

The user uses the controls to select web sites for a guided tour 58. As the user navigates a particular web site or a group of web sites on the Internet, the user presses the record button whenever they want to add a particular screen to the guided tour. The user continues to navigate through the Internet, until they have added all of the web pages they desire to add, and then the user presses the stop button. This allows the user to navigate to a specific page without recording all of the pages in between, and only add the specified page to the guided tour.

Whenever a user presses the record button, the guided tour frame grabs information from the window in which the user is viewing the web page that the user wants to record. The information grabbed from the window includes the hyperlink address of the web page as well as any additional navigation information, such as special characters that must be submitted for active web pages to be generated, and saves the information into a database. The web page is also assigned a sequential number so that the web pages are displayed in the order that they were recorded. In an additional embodiment of the present invention, the guided tour server also stores the amount of time that the user spends on the page.

In an additional embodiment, at a preselected time interval or upon the occurrence of a respecified event, such as the alteration of a web page selected for the guided tour, a verification tool checks each of the hyperlink addresses of the web pages in the guided tour to ensure that the hyperlinks are valid. If a hyperlink is no longer valid because the location of the web page has moved or the information to retrieve the selected web page has changed, then the user is notified. If the location of the web page has moved and the new location is known, then the verification tool updates the web page information stored in the database to reflect the new address of the web page.

In another embodiment, the verification tool works from the web site administrator point of view, so that if a web site administrator changes a page on the web site, the verification tool looks to see if that web page is referenced in any guided tours. If the web page is referenced in a guided tour, then the verification tool updates the web page information stored in the database. If the web page was substantially altered or deleted by the web site administrator, then the verification tool notifies the user who created the guided tour of the change.

In an embodiment, the actual web page viewed by the user is copied in its entirety, stored on the guided tour server, and indexed in a database for retrieval. This embodiment is beneficial because it prevents changes in the web sites being shown in the guided tour from affecting the guided tour. In an alternative embodiment, the guided tour server uses the web page address saved in the database to access the web page at the time the guided tour is viewed. This embodiment is beneficial for situations where web pages change often, and the builder of the guided tour wants a viewer to see the most recently updated page.

In an additional embodiment, once the user presses the record button, every keystroke entered by a user and the navigation information for any web sites viewed by the user until the user presses the stop button are sent from the user device to the guided tour server where they are saved. This allows the user to disregard the recording process and concentrate on navigating through one or more sites as they normally would. As explained below, the user is later prompted to edit the guided tour, at which time they can remove unwanted web pages. Each web page saved by the user is entered into a database, with a sequential indicator, along with any keystrokes entered by the user while the user is viewing the web page.

Once the user has recorded a guided tour, the user is prompted to edit the guided tour 60. In an embodiment, each web page is displayed as a thumbnail, and the user can move thumbnails to change the order of display in the tour. When a user graphically rearranges the order, the web pages are reordered in the database to reflect the new order. In an embodiment, the default order is the order in which the pages were recorded. In an additional embodiment, the user building the guided tour can cut, copy, insert before, and insert after web pages to create the desired chronology. In an additional embodiment, sequencing is performed by highlighting the selected page and using forward and backward buttons to position the selected pages at a different location.

In an embodiment, the user is prompted to enter the amount of time that a given screen is to be displayed for a user. In an alternative embodiment, the user is prompted to record an audio track that is to be played as one or more web pages in the guided tour are displayed. The user is also prompted to delete one or more web pages and to record additional web pages for insertion into the guided tour.

The user can add annotations to each web page displayed in the guided tour. In particular, the guided tour maker can add text, audio, video, graphics, and hotlinks to a particular web page being displayed. In an embodiment, the user appends the annotations to the web page during the editing process. Each annotation is stored in a database in such a way that the guided tour server can reconstruct the annotation as the server software builds the web pages during the guided tour. For example, if the annotation is a phrase displayed at a particular location on the screen, the location of the phrase is saved along with the phrase, so that the server can regenerate the annotation in the proper location on the screen.

When a user presses the audio start button, the system saves the web page that the viewer is viewing. The audio start button also opens up audio recording software resident on the user's machine. The audio recording software records any sound until the stop audio recording button is pressed. Once the stop audio recording button is pressed, the audio recording software is instructed to end the recording, and save the recording to a file in a temporary directory. In an embodiment of the present invention, the name assigned to the recorded audio file is related to the name of the web page which is being viewed at the time that the audio file is being recorded. After the file is saved into a temporary directory, the file is uploaded to the guided tour server. The audio file is linked to a particular web page in the guided tour in the database. When the particular web page is viewed, the corresponding audio file is played. Any timing specified for web page viewing will be modified to correspond to at least the length of the corresponding audio file.

In an embodiment, the guided tour can be set up to be viewed automatically without requiring the user to click on any button. The user is provided with a means to input the length of time for each page to be displayed, either a constant time for all pages, or a different time for each page. Where the builder of the guided tour has selected durations for each web age display, the guided tour server initiates a timer as each web page of the guided tour is sent to the viewer. When the time elapsed equals the time specified by the user and saved in the database for the web page to be displayed, the guided tour server pushes the next web page in the guided tour to the viewer's Internet browser.

After a particular guided tour has been created, the user may protect the guided tour with a name and password function so that the guided tour cannot be viewed by anyone not authorized by the creator of the guided tour. Additionally, the creator or an authorized agent of the creator can add an expiration to the guided tour, so that the guided tour will not be viewable after a particular date and time. If the guided tour is password protected, an appropriate username and password can be mailed to a user along with the address of the guided tour server. In a embodiment, the username and password is embedded in the guided tour link sent to the receiver.

In an exemplary embodiment, guided tours can be created by web masters or web site visitors. Pre-formed guided tours can be assembled and displayed for visitors to a web site to view. For example, on a travel web site that has photographs of San Francisco, a user may create a guided tour of Golden Gate Park, showing various plants of the park, based upon a subset of the collection of web pages available on the web site. Another user may create a guided tour of Fisherman's Wharf using a subset of the web pages available on the web site. A new user to the web site, may click on either guided tours or view the site themselves and possibly create their own.

In an additional embodiment, a travel agent may create a guided tour of a specific city or country, using a multitude of third party web sites, based upon the travel agent's understanding of the desires of a client. The travel agent stores the guided tour on the guided tour server and forwards to the client the address of the guided tour on the guided tour server. The client may then direct their Internet browser to the guided tour link in the e-mail from the travel agent and view the guided tour.

In another possible application of the invention, a salesperson may create a guided tour of a product and send the guided tour to a potential buyer. For example, in the area of real estate, the agent can create a guided tour including web pages containing pictures of a house, local school web pages, local chamber of commerce pages, interest rate tables, etc., so that a potential home buyer can be provided with a large quantity of relevant information quickly.

If a user elects to edit an existing guided tour from the main menu, then the user is presented with a list of previously built guided tours. The user is prompted to select a guided tour to edit. Once the user selects a guided tour to edit, the user is prompted to edit the attributes of the guided tour as described above.

If a user elects to view a guided tour, then the user is presented with a list of previously built guided tours. The user is prompted to select a guided tour for viewing. Once the viewer selects a guided tour, the user is presented with the same options as a viewer who was sent a link to the guided tour as described below.

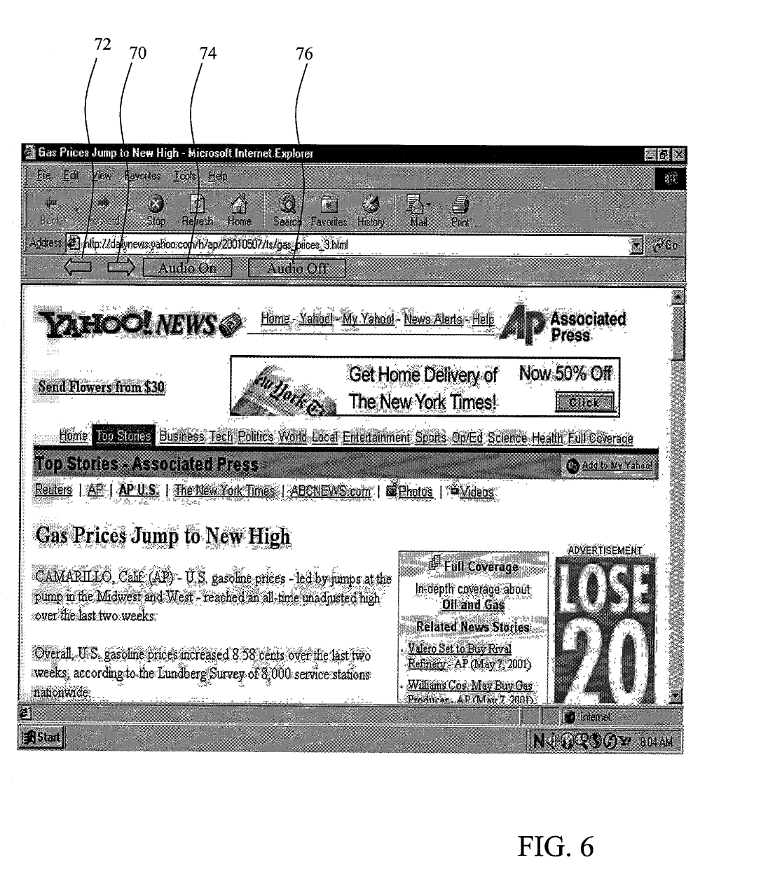

In an addition embodiment, instead of the guided tour advancing automatically based on a timer or based upon the length of an annotation, the person viewing the guided tour is presented with a frame or window containing navigation buttons. In an alternative embodiment, the navigation controls are found in a pull down menu. In yet another alternative embodiment, the navigation controls are the arrow keys on a keyboard to allow the maximum possible screen area for viewing of the guided tour. In a preferred embodiment, shown in FIG. 6, the user is presented with navigation controls allowing them to go forward 70, backward 72, to turn the audio on 73 and to turn the audio off 74.

When the user selects the go forward control 70, the user is shown the web page that is next in the sequence of the guided tour, as defined by the creator of the guided tour. In an embodiment, when the user presses the forward control, a request is sent to the guided tour server for information about the next web page in the guided tour. The guided tour server accesses the database containing the guided tour information, retrieves information about the next web page in the guided tour and transmits the information about the next web page in the guided tour to the user. When the user selects the go backward control, the user is returned to the web page viewed previously. The user can continue to go forward or backward as they please.

In yet another embodiment, when the user presses the forward control, the user is shown the path that the guided tour builder took to get from the current screen to the next screen. The hotlink pressed by the guided tour builder may be saved as an annotation. Alternatively, the guided tour server may reconstruct the path from the current web page to the next web page in the guided tour by reviewing all of the hotlinks in the current page and determining if any lead to the next page in the guided tour.

In an embodiment of the present invention, the hotlinks resident on the pages viewed in the guided tour are disabled. In an alternative embodiment, the hotlinks found in the web pages of the guided tour are active, and the user can select any link they want. The user may then freely navigate, until they are ready to continue the guided tour. When the user is ready to continue the guided tour, the user selects the go forward control and then is provided with the next web page in the guided tour as selected by the creator of the guided tour.

In another embodiment, the user is presented with a control that allows them to see an index of the pages in the tour. When the user elects to see an index of the web pages in the guided tour, the guided tour server, creates an index based on the web pages saved in the database. The index can include all pages in the tour, or can include selected pages. This way, the viewer of the guided tour can jump to the portion that interests the viewer the most. This index can be presented as thumbnails or as titles of the pages.

In another embodiment, a user can build a guided tour based upon another already created guided tour. The new guided tour can simply reference the previous one by linking to it. Alternatively, the new guided tour can contain as its own web pages, the web pages selected in another guided tour.

Although a user is provided with controls for advancing the guided tour, the guided tour can be configured to run automatically, as in a slide show, without the user clicking on any controls. The guided tour can be configured to push the next web page to the viewer based upon a preselected time interval. Alternatively, the time interval can be established by the length of an annotation, such as an audio file, specified for a given web page, with the guided tour server forwarding the next web page to a viewer at the conclusion of the annotation.

In an embodiment, the guided tour is not restricted to one web site, but rather can travel to many different web sites. This is possible, because during the building of the guided tour, either the address of the third party web site or the pages viewed on the third party web site themselves are saved in a database. Therefore, at the time the viewer is viewing the guided tour, the third party web pages are accessible.

A link to the guided tour can be e-mailed to a potential viewer. Alternatively, an executable program such as an EXE file can be e-mailed to a potential viewer. This executable program accesses the Internet and caches the web pages in the guided tour for viewing. The executable can be sent, for example, as an attachment to an e-mail, on a floppy disc, or on a business card readable by a compact disk drive.

In an additional embodiment, a desktop application is created that communicates with the guided tour server site to determine what guided tours are available to a user. Once the desktop application has obtained information about the guided tours available, the desktop application displays the guided tours for a user to choose. In an alternative embodiment, instead of a desktop application, the user is provided with a web browser plug-in that communicates with the guided tour server.

In an additional embodiment, advertisements are appended to guided tours as annotations. In an embodiment, the advertisement information and any relevant formatting information is stored in a database corresponding to the web page with which the advertisement is correlated. In an additional embodiment, the Internet address for the advertisement is also stored so that a user can click on the advertisement during the guided tour and direct their Internet browser to a specific web site. Additionally, a link may be displayed during the guided tour to direct a viewer's Internet browser to the guided tour builder's web page.

The preceding description has been presented with reference to the presently preferred embodiments of the invention shown in the drawings. Workers skilled in the art and technology to which this invention pertains will appreciate that alterations and changes in the described structures can be practiced without departing from the spirit, principles and scope of this invention.

Accordingly, the foregoing description should not be read as pertaining only to the precise structure described, but rather should be read consistent with, and as support for the following claims.

What is claimed is:

1. A method for electronically providing a guided tour using a plurality of web pages comprising the steps of:
storing information about a plurality of web pages in a database;
storing information about an order of display of the plurality of web pages in the database;
receiving a request for web page information;
sending the information about a plurality of web pages to a user to enable the user to view the plurality of web pages in the order of display stored in the database.

2. The method of electronically providing a guided tour of claim 1 further comprising:
prompting a first user to select a plurality of web pages for a guided tour;
receiving from the first user information about a plurality of web pages;
prompting the first user to select an order for sending information about the selected plurality of web pages to a second user; and
receiving from the first user an order for sending information about the selected plurality of web pages to the second user.

3. The method of electronically providing a guided tour of claim 2 further comprising:
prompting the first user to select a time lapse in between the sending of each of the plurality of web pages to the second user;
receiving from the first user a time lapse to be tolled before sending information about each of a plurality of web pages to the second user;
storing the time lapse received from the first user in the database; and
tolling the time lapse received from the first user before sending information about each of the plurality of web pages to the second user.

4. The method of electronically providing a guided tour of claim 1 wherein the information about each of a plurality of web pages comprises the location of the web page and request information to generate the web page.

5. The method of electronically providing a guided tour of claim 2 further comprising:
prompting the first user to add an annotation onto each of the plurality of web pages;
receiving from the first user an annotation to at least one of the plurality of web pages;
storing the annotation to at least one of the plurality of web pages to the database;
sending to the second user information about the annotation along with the information about the corresponding web page to the annotation.

6. The method of electronically providing a guided tour of claim 5 wherein the annotation is at least one of the group consisting of text, graphics, sound, and video.

7. The method of electronically providing a guided tour of claim 1 further comprising:
prompting the second user to receive information about a web page earlier in the order to the one of the plurality of web pages last sent;
receiving from the second user a request to receive information about a web page earlier in the order to the one of the plurality of web pages last sent; and
sending to the second user information about a web page earlier in the order to the one of the plurality of web pages last sent.

8. The method of electronically providing a guided tour of claim 7 further comprising:
prompting the second user to receive information about a web page later in the order to the one of the plurality of web pages last sent;
receiving from the second user a request to receive information about a web page later in the order to the one of the plurality of web pages last sent;
sending to the second user information about a web page later in the order to the one of the plurality of web pages last sent.

9. The method of electronically providing a guided tour of claim 1 further comprising:
sending to the second user a list containing information about each of the plurality of web pages for which information is stored in the database;
prompting the second user to receive information about one of the plurality of web pages;
receiving from the second user a selection of one of the plurality of web pages; and
sending to the second user information about the one of the plurality of web pages selected by the user.

10. The method of electronically providing a guided tour of claim 2 further comprising:
receiving from the first user an expiration date;
storing the expiration date in the database;
comparing the expiration date to a current date; and
refusing a request from the second user if the current date is later than the expiration date.

11. A system for providing electronic guided tours comprising:
a first user device coupled to a computer network;
a second user device coupled to the computer network;
a database coupled to the computer network for storing information about a plurality of web pages and about the order that the plurality of web pages are displayed in a guided tour;
a server coupled to the computer network, configured to receive information about the plurality of web pages and information about the order that the plurality of web pages are displayed in a guided tour from a first user device, store the information about the plurality of web pages and information about the order that the web pages are displayed in a guided tour in the database, receive a request for a guided tour from a second user device, and to transmit information from the database about a plurality of web pages to the second user device in the order stored in the database.

12. The system for providing electronic guided tours of claim 11 wherein the server is further configured to prompt a user of the first user device to select a time lapse in between the transmittal of each of the plurality of web pages to the second user device, receive from the first user device a time lapse to be tolled before transmitting information about each of the plurality of web pages to the second user device, store the time lapse in the database, and toll the time lapse between transmitting each of the plurality of web pages to the second user device.

13. The system for providing electronic guided tours of claim 12 wherein the server is further configured to prompt the user of the first user device to provide an annotation to correspond to the information about at least one of the plurality of web pages stored in the database, receiving from the user an annotation corresponding to at least one of the plurality of web pages stored in the database, store the received annotation in the database, and transmit the annotation corresponding to at least one of the plurality of web pages stored in the database along with the information on the one of the plurality of web pages.

14. The system for providing electronic guided tours of claim 13 wherein the annotations that the user of the first user device is prompted to provide include at least one of the group consisting of text, graphics, audio and video.

15. The system for providing electronic guided tours of claim 11 wherein the computer network is the Internet.

16. A computerized method for creating a guided tour over a computer network comprising the steps of:
receiving from a first user information about a plurality of web pages and an order for transmitting the information about the plurality of web pages to a second user;
obtaining the web pages corresponding to the information about a plurality of web pages received from a first user;
storing the plurality of web pages and the order for transmitting the plurality of web pages to the second user in a database;
receiving a request for the plurality of web pages from the second user; and
transmitting the plurality of web pages to the second user in the order received from the first user.

17. The computerized method for creating a guided tour over a computer network of claim 15 further comprising the steps of:
receiving from the first user a plurality of time lapses for tolling in between transmitting each of the plurality of web pages to the second user;
storing information about the plurality of time lapses for tolling in between transmitting each of the plurality of web pages to the second user in the database; and
tolling each of the plurality of time lapses in between transmitting each of the plurality of web pages to the second user.

18. The computerized method for creating a guided tour over a computer network of claim 16 further comprising the steps of:
prompting the first user to provide an annotation to correspond to at least one of the plurality of web pages;
receiving from the user an annotation corresponding to at least one of the plurality of web pages;
aggregating the annotation and the corresponding at least one of the plurality of web pages;
storing the aggregated annotation and the corresponding at least one of the plurality of web pages in the database; and
transmitting the aggregated annotation and the corresponding at least one of the plurality of web pages to the second user.

19. The computerized method for creating a guided tour over a computer network of claim 18 wherein the prompting of the first user to provide an annotation further comprises prompting the first user to provide at least one of the group consisting of text, graphics, audio and video.

20. The computerized method for creating a guided tour over a computer network of claim 16, wherein the computer network is the Internet.

21. A computer readable medium having stored thereon a set of instructions including instructions for creating a guided tour of web pages, the instructions, when executed by a microprocessor, cause the microprocessor to perform the steps of:
prompting a first user to enter information about a plurality of web pages and an order for transmitting the plurality of web pages to a second user;
receiving from the first user information about a plurality of web pages and the order for transmitting the plurality of web pages to the second user;
storing the information about a plurality of web pages and the order for transmitting the plurality of web pages to the second user;
receiving from the second user a request for the information about the plurality of web pages; and
transmitting the information about the plurality of pages to the second user in the order for transmitting received from the first user.
